(19) United States
(12) Patent Application Publication
(10) Pub. No.: US 2024/0034293 A1
(43) Pub. Date: Feb. 1, 2024

(54) BRAKING SYSTEM FOR AN AT LEAST TWO-AXLE VEHICLE

(71) Applicant: Robert Bosch GmbH, Stuttgart (DE)

(72) Inventor: Dirk Mahnkopf, Eglosheim (DE)

(21) Appl. No.: 18/257,496

(22) PCT Filed: Dec. 9, 2021
(86) PCT No.: PCT/EP2021/084966

§ 371 Date: Jul. 12, 2023

(30) Foreign Application Priority Data
Dec. 18, 2020 (DE) 10-2020 216 322.7

(51) Int. Cl. B60T 8/94; B60T 8/1755; B60T 7/12; B60T 13/68; B60T 7/04; B60T 11/16; B60T 13/62

(52) U.S. Cl. CPC B60T 8/94; B60T 8/1755; B60T 7/12; B60T 13/686; B60T 7/04; B60T 11/165; B60T 13/62; B60T 2270/402; B60T 2270/413; B60T 2201/02

(57) ABSTRACT

A braking system for an at least two-axle vehicle. The braking system including a first axle unit, which includes: a first motorized brake pressure buildup device, a first wheel-brake cylinder hydraulically connected at a first motorized brake pressure buildup device and mountable at a first wheel of a first axle of the vehicle, and a second wheel-brake cylinder hydraulically connected at the first motorized brake pressure buildup device and mountable at a second wheel of the first axle; and a second axle unit designed to be hydraulically separate from the first axle unit, the first axle unit also including, in addition to the first motorized brake pressure buildup device a second motorized brake pressure buildup device, at which the first wheel-brake cylinder and the second wheel-brake cylinder are hydraulically connected.

### FIELD

The present invention relates to a braking system for an at least two-axle vehicle. The present invention also relates to a method for operating a braking system of an at least two-axle vehicle.

### BACKGROUND INFORMATION

Braking systems for vehicles with at least two axles are described in the related art such as, for example, in German Patent Application No. DE 10 2016 208 529 A1, and include in each case four wheel-brake cylinders, each wheel-brake cylinder being hydraulically connected at a main brake cylinder of the respective braking system to a brake pedal situated upstream from the main brake cylinder.

### SUMMARY

The present invention provides a brake cylinder for an at least two-axle vehicle and a method for operating a braking system of an at least two-axle vehicle.

The present invention provides braking systems for at least two-axle vehicles that have a comparatively compact design and are producible at relatively low manufacturing costs. As will become clear based on the following description, the conventional hydraulic lines between the at least two axles of the vehicle equipped in each case with the braking system are omitted in a braking system according to the present invention. This produces a savings of a relatively large amount of installation space on the respective vehicle. This also facilitates a mounting of the braking system according to the present invention on the respective vehicle.

As also becomes clear based on the following description, it is possible in a braking system according to the present invention to fully automatically/fully autonomously set the respective brake pressure in its first axle unit, i.e., without a driver braking force being provided by a driver. This may also be referred to as a fully automatic/fully autonomous pressure setting. A failure of one of the two motorized brake pressure buildup devices of the first axle unit of the braking system according to the present invention may also be easily compensated for with the aid of an (increased or alternative) use of the other of the two motorized brake pressure buildup devices. The braking systems according to the present invention are thus advantageously suitable for use in vehicle types for autonomous driving.

The first axle unit is preferably a “front axle unit.” In the braking system according to the present invention, it is thus possible to fully automatically/fully autonomously set an initial brake pressure in the first wheel-brake cylinder used as the front-axle wheel-brake cylinder and a second brake pressure in the second wheel-brake cylinder also used as the front-axle wheel-brake cylinder, i.e., without a driver braking force being provided by a driver of the respective vehicle.

In one advantageous specific embodiment of the braking system of the present invention, a first control device of the first axle unit is designed and/or programmed, while taking into account at least one braking setpoint signal, which is output by at least one brake actuator sensor of the vehicle to the first control device, by an automatic speed control system of the vehicle, by a second control device of the second axle unit and/or by a further stabilizing device of the braking system, to activate the first motorized braking pressure buildup device and the second motorized brake pressure buildup device in such a way that, at least temporarily, brake fluid is transferable into the first wheel-brake cylinder and into the second wheel-brake cylinder with the aid of an operation of the first motorized brake pressure buildup device, and at least temporarily, brake fluid is transferable into the first wheel-brake cylinder and into the second wheel-brake cylinder with the aid of an operation of the second motorized brake pressure buildup device.

The first control device is thus able to respond to a failure of one of the two motorized brake pressure buildup devices of the first axle unit with a compensating use of the other of the two motorized brake pressure buildup devices of the first axle unit.

An active pressure buildup in the first wheel-brake cylinder and/or in the second wheel-brake cylinder is thus possible even in the “non-mechanical” fall-back level of the first axle unit effectuated in this way. An autonomous deceleration of the respective vehicle with the aid of its first axle unit, in particular, is also possible in the “non-mechanical” fall-back level.

According to an example embodiment of the present invention, the first axle unit is preferably designed to be hydraulically separate from the second axle unit in such a way that the first axle unit and the second axle unit are connected to one another at most via at least one signal line and/or bus line connected at the first control device and at the second control device.

Thus, the conventional hydraulic lines between the first axle and the second axle of the vehicle equipped with the braking system described herein are omitted in the specific embodiment of the braking system described herein.

For example, the first motorized brake pressure buildup device may be hydraulically connected via a forked first hydraulic path at the first wheel-brake cylinder and at the second wheel-brake cylinder, a first separating valve and/or a second separating valve being situated in the first hydraulic path in such a way that while brake fluid is transferable into the second wheel-brake cylinder with the aid of the first motorized brake pressure buildup device, the first wheel-brake cylinder is decouplable via a closing of the first separating valve by the first motorized brake pressure buildup device, and/or while brake fluid is transferable into the first wheel-brake cylinder with the aid of the first motorized brake pressure buildup device, the second wheel-brake cylinder is decouplable from the first motorized brake pressure buildup device via a closing of the second separating valve. Thus, in the specific embodiment of the braking system of the present invention described herein, a wheel-specific pressure setting in both wheel-brake cylinders of the first axle unit is implementable with the aid of the operation of the first motorized brake pressure buildup device.

This may also be described as a wheel-specific fully automatic/fully autonomous pressure setting in the wheel-brake cylinders of the first axle unit of the braking system according to the present invention described herein. It is noted, however, that a switching of the first separating valve and/or of the second separating valve for the wheel-specific fully automatic/fully autonomous pressure setting in the wheel-brake cylinders is generally necessary only for a modulation such as, for example, an ESP control or ABS control. For this reason, valve switching noises occur relatively seldom during an operation of the braking system according to the present invention described herein. Reference is therefore also made to good noise vibration harshness (NVH) characteristics of the braking system according to the present invention described herein.

According to an example embodiment of the present invention, the second motorized brake pressure buildup device may, in particular, be hydraulically connected at the first wheel-brake cylinder and at the second wheel-brake cylinder via a forked second hydraulic path, a third separating valve and/or a fourth separating valve being situated in the second hydraulic path in such a way that while brake fluid is transferable into the second wheel-brake cylinder with the aid of the second motorized brake pressure buildup device, the first wheel-brake cylinder is decouplable via a closing of the third separating valve by the second motorized brake pressure buildup device, and/or while brake fluid is transferable into the first wheel-brake cylinder with the aid of the second motorized brake pressure buildup device, the second wheel-brake cylinder is decouplable via a closing of the fourth separating valve by the second motorized brake pressure buildup device. The specific embodiment of the braking system of the present invention described herein thus also offers as an advantageous refinement the possibility of wheel-specific pressure setting in both wheel-brake cylinders of the first axle unit with the aid of an operation of the second motorized brake pressure buildup device.

According to an example embodiment of the present invention, the first axle unit preferably also includes a main brake cylinder, at which a brake actuator of the vehicle is connectable or is connected in such a way that at least one piston of the main brake cylinder delimiting at least one chamber of the main brake cylinder is adjustable with the aid of an actuation of the brake actuator by a driver of the vehicle, the at least one chamber of the main brake cylinder being hydraulically connected at the first motorized brake pressure buildup device, at the second motorized brake pressure buildup device, at the first hydraulic path and/or at the second hydraulic path via at least one valveless or valve-equipped connecting line. Thus, with the aid of his/her driver braking force, the driver has the option of braking directly into the wheel-brake cylinders of the first axle unit in order in this way to also effectuate an (additional) brake pressure buildup in the wheel-brake cylinders of the first axle unit. The specific embodiment of the braking system of the present invention described herein thus also includes a mechanical fall-back level.

According to an example embodiment of the present invention, the first motorized brake pressure buildup device may advantageously be a plunger device and the single chamber or at least one of the chambers of the main brake cylinder may be hydraulically connected at a first plunger chamber of the first plunger device via the single connecting line or via at least one of the connecting lines, a first opening of the single connecting line or at least of one of the connecting lines at the first plunger chamber being designed in such a way that, if an adjustable first plunger piston of the first plunger device is present in its initial position, brake fluid is transferable out of the main brake cylinder through the first opening into the first plunger chamber, whereas if the first plunger piston is moved out its initial position, a brake fluid transfer out of the main brake cylinder through the first opening into the first plunger chamber is prevented with the aid of at least one first sealing element attached at the first plunger piston and/or in the first plunger chamber. Thus, during an operation of the first plunger device, the main brake cylinder is automatically “decoupled” from the first plunger device. Nevertheless, the specific embodiment of the braking system described herein is automatically transferred into its fall-back level in the case of a failure of the first plunger device, in which the driver is able to brake into the wheel-brake cylinders of the first axle unit via the main brake cylinder and the first plunger device with the aid of his/her driver braking force. A switching of a valve is therefore unnecessary for transferring the specific embodiment of the braking system of the present invention described herein into the mechanical fall-back level.

As an advantageous refinement, according to an example embodiment of the present invention, the second motorized brake pressure buildup device may also be a second plunger device and the single chamber or at least one of the chambers of the main brake cylinder may be hydraulically connected at a second plunger chamber of the second plunger device via at least one of the connecting lines, a second opening of at least one of the connecting lines at the second plunger chamber being designed in such a way that, if an adjustable second plunger piston of the second plunger device is present in its initial position, brake fluid is transferable out of the main brake cylinder through the second opening into the second plunger chamber, whereas, if the second plunger is moved out of its initial position, a brake fluid transfer out of the main brake cylinder through the second opening into the second plunger chamber is prevented with the aid of at least one second sealing element attached at the second plunger piston and/or in the second plunger chamber. This improves the transfer of the braking system described in the previous paragraph into the mechanical fall-back level.

Alternatively or in addition, according to an example embodiment of the present invention, at least one main brake cylinder decoupling valve may also be situated in the at least one connecting line. A transfer of the specific embodiment of the braking system described herein into its mechanical fall-back level is thus also possible via a switching of the at least one main brake cylinder decoupling valve.

The previously described advantages are also ensured when carrying out a corresponding method for operating a braking system of an at least two-axle vehicle. It is expressly noted that the method for operating a braking system of an at least two-axle vehicle may be refined in accordance with the specific embodiments of the braking system explained above.

### BRIEF DESCRIPTION OF THE DRAWINGS

Further features and advantages of the present invention are explained below with reference to the figures.

FIGS. 1 through 8 schematically show partial representations of specific embodiments of the braking system of the present invention.

FIG. 9 shows a flowchart for explaining one specific embodiment of the method for operating a braking system of an at least two-axle vehicle, according to the present invention.

### DETAILED DESCRIPTION OF EXAMPLE EMBODIMENTS

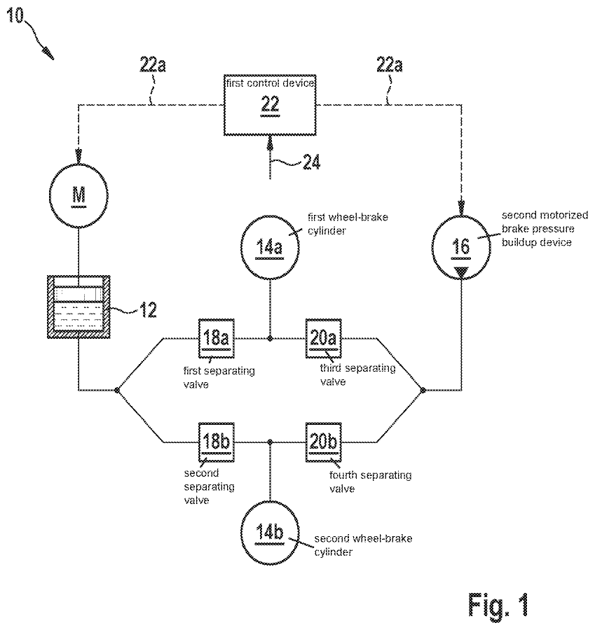

FIG. 1 schematically shows a partial representation of a first specific embodiment of the braking system.

The braking system schematically represented in FIG. 1 is mountable/is mounted at an at least two-axle vehicle/motor vehicle, a suitability of the braking system not being limited to any specific vehicle type/motor vehicle type of the two-axle vehicle/motor vehicle.

The braking system of FIG. 1 includes a first axle unit 10, including a first motorized brake pressure buildup device 12, a first wheel-brake cylinder 14a hydraulically connected at the first motorized brake pressure buildup device 12 and a second wheel-brake cylinder 14b also hydraulically connected at first motorized brake pressure buildup device 12. As a result, both a first brake pressure in first wheel-brake cylinder 14a and a second brake pressure in second wheel-brake cylinder 14b may be fully automatically/fully autonomously set with the aid of first motorized brake pressure buildup device 12, i.e., without a driver braking force being provided by a driver of the respective vehicle, at least at the same pressure value. In addition to first motorized brake pressure buildup device 12, first axle unit 10 also has a second motorized brake pressure buildup device 16, at which first wheel-brake cylinder 14a and second wheel-brake cylinder 14b are also hydraulically connected. A fully automatic/fully autonomous brake pressure buildup in first wheel-brake cylinder 14a and in second wheel-brake cylinder 14b may thus be effected more rapidly with the aid of second motorized brake pressure buildup device 16 or without first motorized brake pressure buildup device 12. First motorized brake pressure buildup device 12 and/or second brake pressure buildup device 16 may, for example, each be a plunger device and/or at least one pump. The first axle unit may thus be designed in a relatively cost-efficient manner. The design of first motorized brake pressure buildup device 12 as a plunger device and second motorized brake pressure buildup device 16 as a pump graphically depicted in FIG. 1 is to be interpreted as merely exemplary.

While first wheel-brake cylinder 14a is mountable/is mounted at a first wheel of a first axle of the vehicle (not depicted), second wheel-brake cylinder 14b is mountable/is mounted at a second wheel of the first axle (not depicted). The braking system also has a second axle unit designed to be hydraulically separate from the first axle unit which, however, is not graphically depicted in FIG. 1. The second axle unit includes at least one motorized device, a first wheel-brake unit hydraulically or mechanically connected at the at least one motorized device and a second wheel-brake unit hydraulically or mechanically connected at the at least one motorized device. The first wheel-brake unit is mountable/is mounted at a first wheel of a second axle of the vehicle, whereas the second wheel-brake unit is mountable/is mounted at a second wheel of the second axle.

The second axle unit may include, for example, as the motorized device a third motorized brake pressure buildup device, as a first wheel-brake unit, a third wheel-brake cylinder hydraulically connected at the third motorized brake pressure buildup device and as a second wheel-brake unit, a fourth wheel-brake cylinder hydraulically connected at the third motorized brake pressure buildup device. The third motorized brake pressure buildup device may, for example, be a plunger device and/or at least one pump. Alternatively, however, the first wheel-brake unit and the second wheel-brake unit may each also be an electro-mechanical wheel brake, at which in each case an assigned electric motor as the at least one motorized device is connected in such a way that the respective electromechanical wheel brake is operable with the aid of its assigned electric motor. The second axle unit may thus be optionally designed as a “hydraulic” axle unit or as an “electric” axle unit. The second axle unit may thus also be designed in a relatively cost-efficient manner.

The hydraulically separate design of first axle unit 10 from the second axle unit is understood to mean that no hydraulic line extends between first axle unit 10 and the second axle unit. Since first axle unit 10 is designed to be hydraulically separate from the second axle unit, the hydraulic lines traditionally required between the axles equipped with the wheel-brake cylinders are omitted in the braking system of FIG. 1. The braking system thus has a very compact and installation space-saving design. A modular design of the braking system is, in particular, implementable at comparatively low manufacturing costs. First axle unit 10 and the second axle unit may also be mounted as two separate units at the two-axle vehicle equipped therewith. This also facilitates a mounting of the braking system described herein.

A high redundancy of first axle unit 10 in the braking system of FIG. 1 is achieved with the aid of a few modifications. In addition, many “identical” parts, i.e., parts of the same type, may be used for first axle unit 10. First axle unit 10 may therefore be comparatively cost-efficiently manufactured braking system components already conventionally in use.

For example, first motorized brake pressure buildup device 12 may be hydraulically connected via a forked first hydraulic path at first wheel-brake cylinder 14a and at second wheel-brake cylinder 14b, a first separating valve 18a and/or a second separating valve 18b being situated in the first hydraulic path in such a way that, while brake fluid is transferable into second wheel-brake cylinder 14b with the aid of first motorized brake pressure buildup device 12, first wheel-brake cylinder 14a is decouplable/is decoupled from first motorized brake pressure buildup device 12 via a closing of first separating valve 18a, and/or, while brake fluid is transferable into first wheel-brake cylinder 14a with the aid of first motorized brake pressure buildup device 12, second wheel-brake cylinder 14b is decouplable/is decoupled from first motorized brake pressure buildup device 12 via a closing of second separating valve 18b. Thus, a wheel-specific pressure setting in both wheel-brake cylinders 14a and 14b of first axle unit 10 of the brake system is implementable by equipping first axle unit 10 with first separating valve 18a and/or with second separating valve 18b. An ESP control or ABS control, for example, is possible as a wheel-specific fully automatic/fully autonomous pressure setting in wheel-brake cylinders 14a and 14b.

Alternatively or in addition, second motorized brake pressure buildup device 16 may also be hydraulically connected at first wheel-brake cylinder 14a and at second wheel-brake cylinder 14b via a forked second hydraulic path, in this case as well, a third separating valve 20a and/or a fourth separating valve 20b being capable of being situated in the second hydraulic path. In this case as well, while brake fluid is transferable into second wheel-brake cylinder 14b with the aid of second motorized brake pressure buildup device 16, first wheel-brake cylinder 14a is decouplable/is decoupled from second motorized brake pressure buildup device 16 via a closing of third separating valve 20a, and/or while brake fluid is transferable into first wheel-brake cylinder 14a with the aid of second motorized brake pressure buildup device 16, second wheel-brake cylinder 14b is decouplable/is decoupled from second motorized brake pressure buildup device 16 via a closing of fourth separating valve 20b. Thus, second motorized brake pressure buildup 16 may also be used for the wheel-specific pressure setting in both wheel-brake cylinders 14a and 14b of first axle unit 10.

The at least one separating valve 18a, 18b, 20a, and 20b of first axle unit 10 may optionally be a switch valve or a continuously adjustable valve suitable for pressure differential setting. The at least one separating valve 18a, 18b, 20a, and 20b is in each case preferably a normally open valve. It is also advantageous if first separating valve 18a and fourth separating valve 20b are each a normally open valve and second separating valve 18b and third separating valve 20a are each a normally closed valve. Alternatively, first separating valve 18a and fourth separating valve 20b may each be a normally closed valve and second separating valve 18b and third separating valve 20a may each be a normally open valve.

As an advantageous refinement, the first axle unit may have a first control device 22, which is designed and/or programed, while taking into account at least one brake setpoint signal 24, to activate at least first motorized brake pressure buildup device 12 and second motorized brake pressure buildup device 16 (potentially also the at least one separating valve 18a, 18b, 20a, and 20b of first axle unit 10) with the aid of at least one control signal 22a in such a way that, at least temporarily, brake fluid is transferable/is transferred into first wheel-brake cylinder 14a and/or into second wheel-brake cylinder 14b with the aid of an operation of first motorized brake pressure buildup device 12 and, at least temporarily, brake fluid is transferable/is transferred into first wheel-brake cylinder 14a and/or into second wheel-brake cylinder 14b with the aid of an operation of second motorized brake pressure buildup device 16. The at least one brake setpoint signal 24 may be output to first control device 22 by at least one brake actuator sensor of the vehicle, by an automatic speed control system of the vehicle, by a second control device of the second axle unit and/or by a further stabilizing device of the braking system. The at least one brake actuator sensor may, for example, be a rod path sensor and/or a differential path sensor. The automatic speed control system may, for example, be an automatic system for driverless driving of the vehicle, an adaptive cruise control and/or an emergency braking system. The further stabilizing device of the vehicle may be understood to mean, in particular, an ESP control unit or an ABS control unit. First axle unit 10 may thus interact with a plurality of different electronic components for pressure setting in wheel-brake cylinders 14a and 14b. As an advantageous refinement, first control device 22 may also be designed to receive and to evaluate sensor signals of a pre-pressure sensor of first axle unit 10 (not shown), of at least one wheel pressure sensor of first axle unit 10 (not graphically depicted), of at least one wheel speed sensor (not graphically depicted), of a yaw rate sensor and/or of an acceleration sensor of at least one of the wheels of the first axle of the vehicle. As a further advantageous refinement, control device 22 may also be designed to also activate at least one generator-driven motor of the vehicle used for recuperative braking of the vehicle which, however, is not delineated in FIG. 1, or to communicate to the motor the information advantageous for the recuperative braking of the vehicle. First axle unit 10 and the second axle unit (not shown) are preferably designed to be hydraulically separate from one another in such a way that first axle unit 10 and the second axle unit are connected to one another at most via at least one signal line and/or bus line connected at first control device 22 and at the second control device of the second axle unit. The connection between first axle unit 10 and the second axle unit implemented in this case with the aid of the signal line and/or bus line is thus space-saving, yet still enables a good interaction of first axle unit 10 and the second axle unit. The at least one signal line and/or bus line may, for example, be a vehicle bus of the vehicle.

First axle unit 10 is mountable/is mounted preferably as a “front axle unit” at the first axle referable to as the front axle of the vehicle, whereas the second axle unit is mountable/mounted as a “rear axle unit” at the second axle referable to as the rear axle of the vehicle. In this case, first axle unit 10 is used for decelerating the front wheels of the vehicle, whereas the rear wheels of the vehicle may be decelerated with the aid of the second axle unit. Alternatively, first axle unit 10 may be mountable/mounted as a “rear axle unit” at the first axle referable to as the rear axle of the vehicle, whereas the second axle unit may be mountable/mounted as a “front axle unit” at the second axle referable to as the front axle of the vehicle.

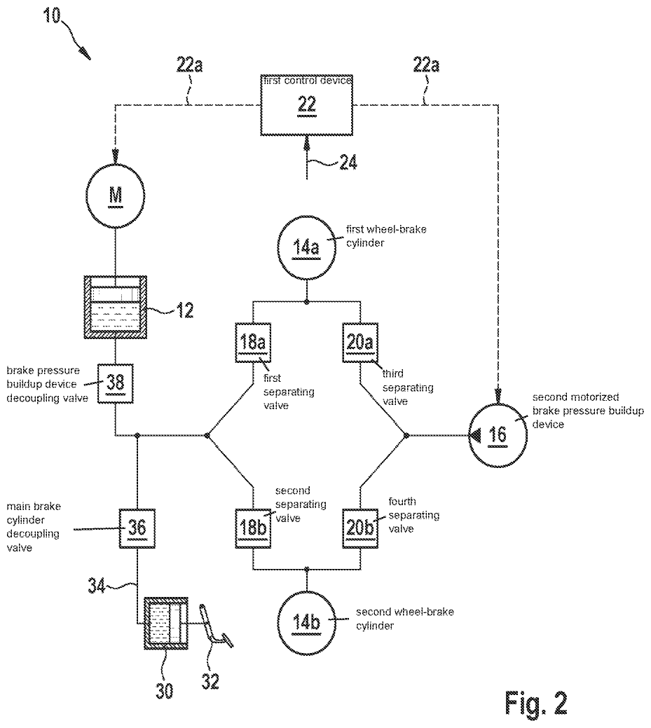

FIG. 2 schematically shows a partial representation of a second specific embodiment of the braking system.

The braking system schematically represented in FIG. 2 also includes as a refinement compared with the specific embodiment of FIG. 1 a main brake cylinder 30 at its first axle unit 10, at which a brake actuator 32 of the vehicle is connectable or is connected in such a way that at least one piston of main brake cylinder 30 delimiting at least one chamber of main brake cylinder 30 is adjustable/is adjusted with the aid of an actuation of brake actuator 32 by a driver of the vehicle. In addition, the at least one chamber of main brake cylinder 30 is hydraulically connected at first motorized brake pressure buildup device 12, at second motorized brake pressure buildup device 16 at the first hydraulic path and/or at the second hydraulic path via at least one valveless or valve-equipped connecting line 34.

Brake actuator 32 may, for example, be a brake pedal 32. Thus, a mechanical fall-back level is designed at the braking system of FIG. 2, in which, in particular, in the event of a failure of first motorized brake pressure buildup device 12 and/or of second motorized brake pressure buildup device 16, the driver is still able to effectuate a brake pressure buildup in wheel-brake cylinders 14a and 14b with the aid of his/her driver braking force applied to brake actuator 32. Thus, even in the case of a failure of the vehicle electrical power system of his/her vehicle, the driver is still able to reliably bring the vehicle to a standstill with the aid of the brake pressure increase effectuated in wheel-brake cylinders 14a and 14b.

At least one main brake cylinder decoupling valve 36 may also be situated in the at least one connecting line 34. Thus, by closing the at least one main brake cylinder decoupling device 36, main brake cylinder 40 may be uncoupled/become uncoupled from first motorized brake pressure buildup device 12 and/or from second motorized brake pressure buildup device 16 during an operation of first motorized braking pressure buildup device 12 and/or of second motorized brake pressure buildup device 16 in such a way that the driver braking force applied to brake actuator 32 has no influence on the brake pressure present in wheel-brake cylinders 14a and 14b, respectively. The at least one main brake cylinder decoupling valve 36 is preferably a normally open valve. Although not represented in FIG. 1, a simulator may also be connected at main brake cylinder 30, so that the driver actuating brake actuator 32 when the at least one main brake cylinder decoupling valve 36 is present in the closed state, has a standard brake actuation feel/pedal feel.

In addition, at least one brake pressure buildup device decoupling valve 38 may also be used in first axle unit 10 in such a way that first motorized brake pressure buildup device 12 and/or second motorized brake pressure buildup device 16 is/are decouplable/decoupled from the at least one connecting line 34 during the mechanical fall-back mode by closing the at least one brake pressure buildup device decoupling valve 38, and thus as a “volume sink,” do not adversely affect the brake pressure increase effectuated with the aid of the driver braking force in wheel-brake cylinders 14a and 14b. For the at least one brake pressure buildup device decoupling valve 38, a normally closed valve is preferred.

Merely as an example, the single connecting line 34 equipped with the main brake cylinder decoupling valve 36 in first axle unit 10 of FIG. 2 opens at a section of the first hydraulic path between brake pressure buildup device decoupling valve 38 situated upstream from first motorized brake pressure buildup device 12 and wheel-brake cylinders 14a and 14b.

With regard to further features and characteristics of the braking system of FIG. 2 and their advantages, reference is made to the previously explained specific embodiment of FIG. 1.

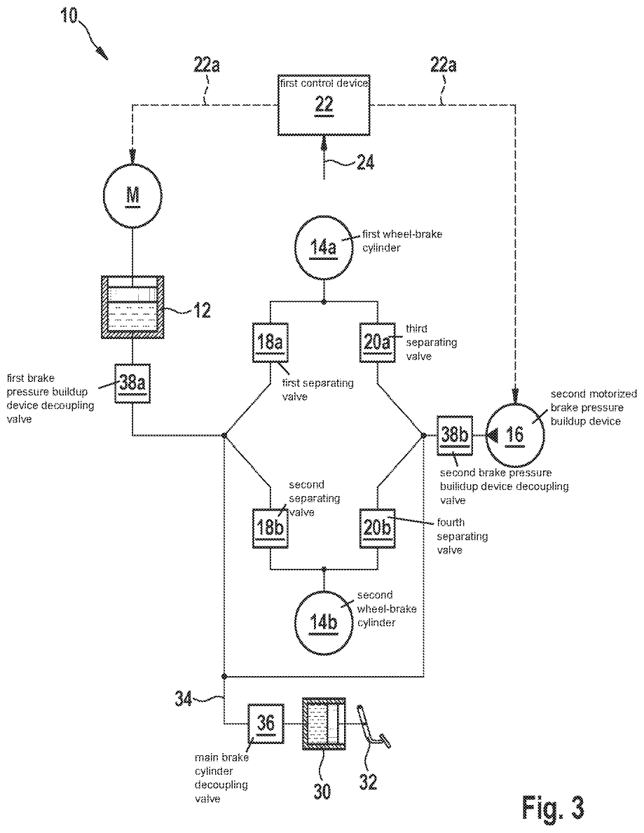

FIG. 3 schematically shows a partial representation of a third specific embodiment of the braking system.

In the braking system schematically represented in FIG. 3, its first axle unit 10 differs from that previously described specific embodiment merely in a fork of single connecting line 34 in such a way that a first opening of connecting line 34 opens at the section of the first hydraulic path between a first brake pressure buildup device decoupling valve 38a situated upstream from first motorized pressure buildup device 12 and wheel brake cylinders 14a and 14b, and a second opening of connecting line 34 opens at a section of the second hydraulic path between a second brake pressure buildup device decoupling valve 38b situated upstream of second motorized brake pressure buildup device 16 and wheel-brake cylinders 14a and 14b.

With regard to further features and characteristics of the braking system of FIG. 3 and their advantages, reference is made to the previously explained specific embodiments of FIGS. 1 and 2.

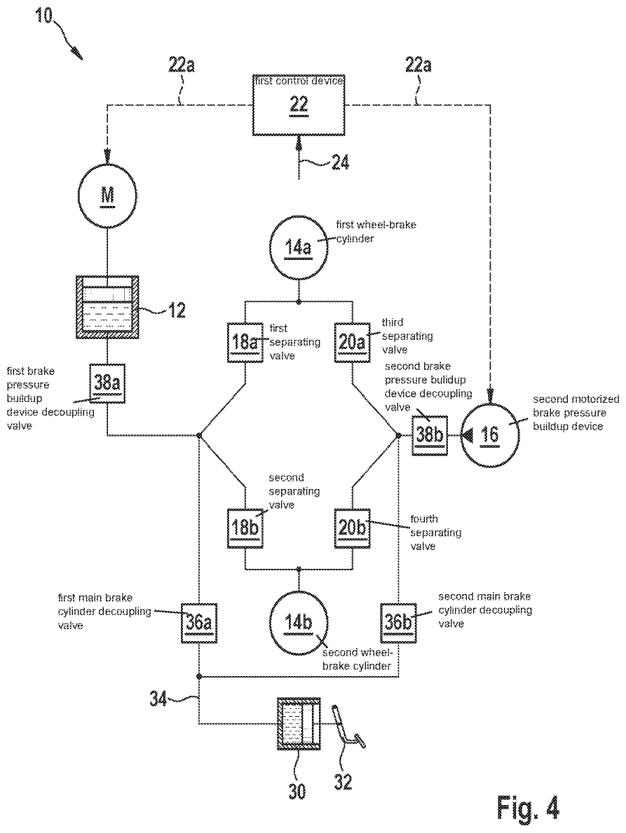

FIG. 4 schematically shows a partial representation of a fourth specific embodiment of the braking system.

Instead of single main brake cylinder decoupling valve 36 of the previously described specific embodiment, the braking system of FIG. 4 has a first main brake cylinder decoupling valve 36a inserted into a section of connecting line 34 between its fork and its first opening, and a second main brake cylinder decoupling valve 36b inserted into a section of connecting line 34 between its fork and its second opening.

With regard to further features and characteristics of the braking system of FIG. 4 and their advantages, reference is made to the previously explained specific embodiments of FIGS. 1 through 3.

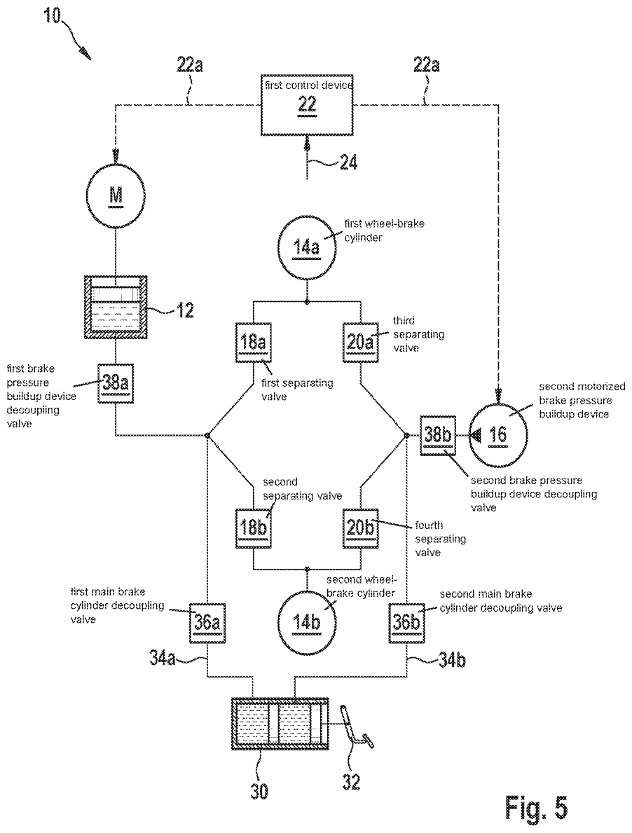

FIG. 5 schematically shows a partial representation of a fifth specific embodiment of the braking system.

In the braking system of FIG. 5, main brake cylinder 30 is a tandem main brake cylinder 30, a first chamber of main brake cylinder 30 being connected with the aid of a first connecting line 34a to first main brake cylinder decoupling valve 36a at the section of the first hydraulic path between first brake pressure buildup device decoupling valve 38a and wheel-brake cylinders 14a and 14b, and a second chamber of main brake cylinder 40 being connected with the aid of a second connecting line 34b to second main brake cylinder decoupling valve 36b at the section of the second hydraulic path between second brake pressure buildup device decoupling valve 38b and wheel-brake cylinders 14a and 14b.

With regard to further features and characteristics of the braking system of FIG. 5 and their advantages, reference is made to the previously explained specific embodiments of FIGS. 1 through 4.

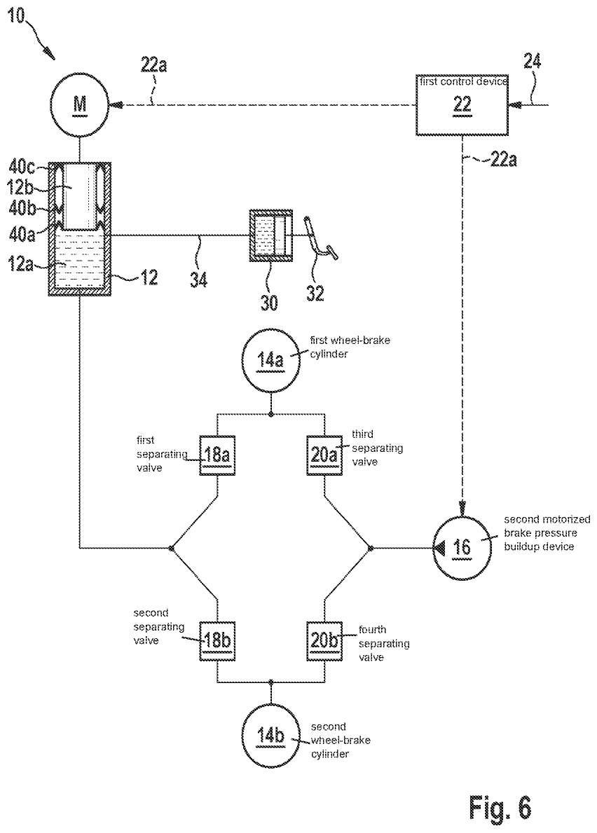

FIG. 6 schematically shows a partial representation of a sixth specific embodiment of the braking system.

In first axle unit 10 schematically represented in FIG. 6, first motorized brake pressure buildup device 12 is a plunger device 12. The single chamber of main brake cylinder 30 is hydraulically connected at a plunger chamber 12a of plunger device 12 via connecting line 34. An opening of connecting line 34 at plunger chamber 12a of plunger device 12 is designed in such a way that, if an adjustable plunger piston 12b of plunger device 12 is present in its respective initial position, brake fluid is transferable/is transferred out of main brake cylinder 30 through the opening of connecting line 34 into plunger chamber 12a of plunger device 12. However, if adjustable plunger piston 12b of plunger device 12 is moved out of its respective initial position, a brake fluid transfer out of main brake cylinder 30 through the opening of connecting line 34 into plunger chamber 12a of plunger device 12 is prevented with the aid of at least one sealing element 40a, 40b, and 40c attached at plunger piston 12b of plunger device 12 and/or in plunger chamber 12a of plunger device 12. The advantageously designed opening of connecting line 34 and the at least one sealing element 40a, 40b, and 40c attached at plunger piston 12b and/or in plunger chamber 12a thus ensure that main brake cylinder 30 is “automatically” uncoupled from plunger device 12 during an operation of plunger device 12 of main brake cylinder 30 present in its functional state, and thus the driver braking force applied to brake actuator 32 has no influence on the wheel-brake pressure present in wheel-brake cylinders 14a and 14b. In the case of a failure of plunger device 12 and/or the vehicle electrical power system of the vehicle, the adjustable plunger piston 12b of plunger device 12 is generally present in its respective initial position, as a result of which the braking system is “automatically” transferred into its mechanical fall-back level, in which the driver is still able to reliably effectuate with the aid of his/her driver braking force a brake pressure increase in wheel-brake cylinders 14a and 14b sufficient enough to decelerate his/her vehicle. Equipping the braking system of FIG. 6 with a main brake cylinder decoupling valve 36 is therefore unnecessary.

In the braking system of FIG. 6, for example, plunger piston 12b of plunger device 12 supports three sealing elements 40a, 40b, and 40c attached thereto. A first sealing element 40a located closest to the opening of connecting line 34 when the plunger piston 12b of plunger device 12 is present in its initial position is blocking for a pressure from the direction of the opening and permeable for a pressure from the (opposite) direction of the motor. A second sealing element 40b adjacent to first sealing element 40a is permeable for a pressure from the direction of first sealing element 40a and blocking for a pressure from the (opposite) direction of the motor. A third sealing element 40c located closest to the motor of plunger device 12 is also blocking for a pressure from the direction of first sealing element 40a and second sealing element 40b and permeable for a pressure from the (opposite) direction of the motor.

With regard to further features and characteristics of the braking system of FIG. 6 and their advantages, reference is made to the previously explained specific embodiments of FIG. 1 through 5.

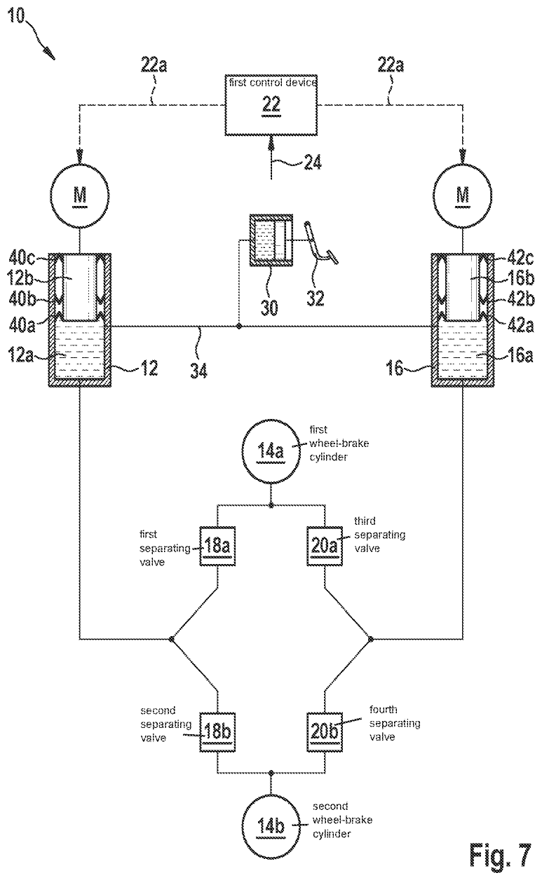

FIG. 7 schematically shows a partial representation of a seventh specific embodiment of the braking system.

As a refinement to the previously described specific embodiment, a plunger chamber 16a of second motorized brake pressure buildup device 16 designed as plunger device 16 is also hydraulically connected in the braking system of FIG. 7 at connecting line 34. An opening of connecting line 34 at plunger chamber 16a of plunger device 16 is designed in such a way that, if an adjustable plunger piston 16b of plunger device 16 is present in its initial position, brake fluid is transferable/is transferred out of main brake cylinder 30 through the opening of connecting line 34 into plunger chamber 16a of plunger device 16. If, however, adjustable plunger piston 16b of plunger device 16 is moved out of its initial position, a brake fluid transfer out of main brake cylinder 30 through the opening of connecting line 34 into plunger chamber 16a of plunger device 16 is prevented with the aid of at least one sealing element 42a, 42b, and 42c attached at plunger piston 16b of plunger device 16 and/or in plunger chamber 16a of plunger device 16. During an operation of plunger device 16 present in its functional state, main brake cylinder 30 is therefore “automatically” uncoupled from plunger device 16, so that the driver braking force applied to brake actuator 32 has no influence on the brake pressure present in each of wheel-brake cylinders 14a and 14b. In the case of a failure of plunger device 16 and/or the vehicle electrical power system of the vehicle, the braking system of FIG. 7 is also “automatically” transferred into its mechanical fall-back level, in which the driver is still able to reliably effectuate with the aid of his/her driver braking force a brake pressure increase in wheel-brake cylinders 14a and 14b sufficient enough to decelerate his/her vehicle.

For example, plunger piston 16b of plunger device 16 includes three sealing elements 42a, 42b, and 42c attached thereto. A first sealing element 42a located closest to the opening of connecting line 34 when plunger piston 16b of plunger device 16 is present in its initial position is blocking for a pressure from the direction of the opening and permeable for a pressure from the (opposite) direction of the motor. A second sealing element 42b adjacent to first sealing element 42a is permeable for a pressure from the direction of first sealing element 42a and blocking for a pressure from the (opposite) direction of the motor. A third sealing element 42c located closest to the motor of plunger device 16 is also blocking for a pressure from the direction of first sealing element 42a and of second sealing element 42b and permeable for a pressure from the (opposite) direction of the motor.

With regard to further features and characteristics of the braking system of FIG. 7 and their advantages, reference is made to the previously explained specific embodiments of FIGS. 1 through 6.

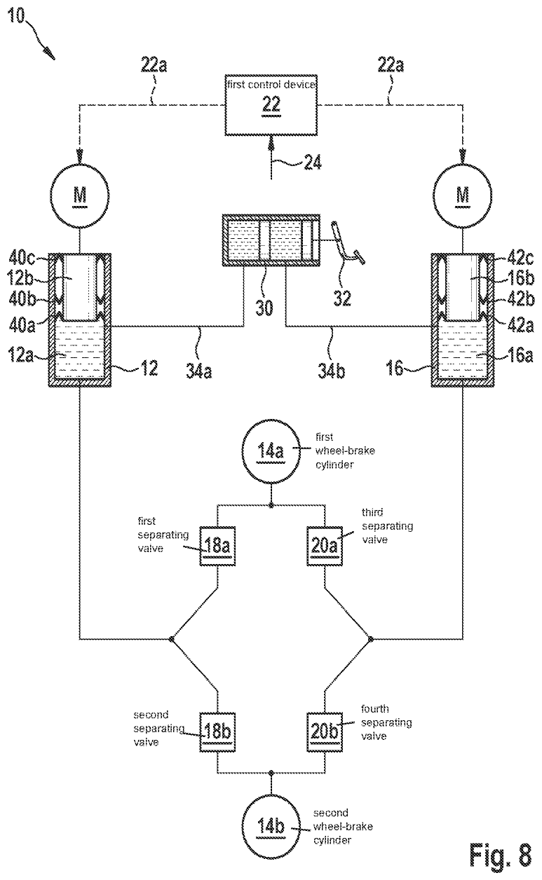

FIG. 8 schematically shows a partial representation of an eighth specific embodiment of the braking system.

Main brake cylinder 30 in the braking system of FIG. 8 is also a tandem main brake cylinder 30. The first chamber of main brake cylinder 30 is connected to plunger chamber 12a of plunger device 12 via a first connecting line 34a. Accordingly, the second chamber of main brake cylinder 30 is connected to plunger chamber 16a of plunger device 16 via a second connecting line 34b. The opening of each connecting line 34a and 34b at plunger chambers 12a or 16a to which they are assigned is designed in accordance with FIGS. 6 and 7. Each of the two plunger pistons 12b and 16b of plunger devices 12 and 16 also support sealing elements 40a, 40b, 40c, 42a, 42b, and 42c already described above.

With regard to further features and characteristics of the braking system of FIG. 8 and their advantages, reference is made to the previously explained specific embodiments of FIGS. 1 through 7.

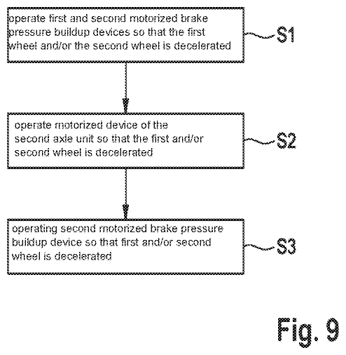

FIG. 9 shows a flowchart for explaining one specific embodiment of the method for operating a braking system of an at least two-axle vehicle.

The method described below may be carried out, for example, with the aid of one of the braking methods explained above. A feasibility of the method is, however, not limited to the use of one of these braking systems. Instead, the method may be carried out using a plurality of different types of braking systems, each of which is designed with a first axle unit including a first wheel-brake cylinder mounted at a first wheel of a first axle of the vehicle/motor vehicle and a second wheel-brake cylinder mounted at a second wheel of the first axle, and including a second axle unit designed to be hydraulically separate from the first axle unit, including a first wheel-brake unit mounted at a first wheel of a second axle of the vehicle/motor vehicle and a second wheel-brake unit mounted at a second wheel of the second axle. A feasibility of the method is also not limited to a specific vehicle type/motor vehicle type of the two-axle vehicle/motor vehicle.

In a method step S1, a first motorized brake pressure buildup device of the first axle unit hydraulically connected at the first wheel-brake cylinder and at the second wheel-brake cylinder is operated in such a way that the first wheel of the first axle and/or the second wheel of the first axle are decelerated. As method step S2, at least one motorized device of the second axle unit hydraulically or mechanically connected at the first wheel-brake unit and at the second wheel-brake unit is also operated in such a way that the first wheel of the second axle and/or the second wheel of the second axle are decelerated. In addition, in method step S3, a second motorized brake pressure buildup device of the first axle unit hydraulically connected at the first wheel-brake cylinder and at the second wheel-brake cylinder is operated in such a way that the first wheel of the first axle and/or the second wheel of the first axle is/are decelerated. Method steps S1 through S3 may be carried out in arbitrary order, temporally overlapping or simultaneously. In this way, the method described above also provides the advantages explained above.

1-10. (canceled)

11. A braking system for an at least two-axle vehicle, comprising:
a first axle unit including a first motorized brake pressure buildup device, a first wheel-brake cylinder hydraulically connected at the first motorized brake pressure buildup device and mountable at a first wheel of a first axle of the vehicle, and a second wheel-brake cylinder hydraulically connectable at the first motorized brake pressure buildup device and mountable at a second wheel of the first axle; and
a second axle unit configured to be hydraulically separate from the first axle unit, the second axle unit including at least one motorized device, a first wheel-brake unit hydraulically or mechanically connected at the at least one motorized device and mountable at a first wheel of a second axle of the vehicle, and a second wheel-brake unit hydraulically or mechanically connected at the at least one motorized device and mountable at a second wheel of the second axle;
wherein the first axle unit includes, in addition to the first motorized brake pressure buildup device, a second motorized brake pressure buildup device, at which the first wheel-brake cylinder and the second wheel-brake cylinder are hydraulically connected.

12. The braking system as recited in claim 11, wherein the first axle unit includes a first control device configured to, while taking into account at least one brake setpoint signal which is output to the first control device by at least one brake actuator sensor of the vehicle, by an automatic speed control system of the vehicle and/or by a second control device of the second axle unit and/or by a further stabilizing device of the braking system, activate the first motorized brake pressure buildup device and the second motorized brake pressure buildup device in such a way that, at least temporarily, brake fluid is transferable into the first wheel-brake cylinder and the second wheel-brake cylinder using an operation of the first motorized brake pressure buildup device, and at least temporarily, brake fluid is transferable into the first wheel-brake cylinder and into the second wheel-brake cylinder using an operation of the second motorized brake pressure buildup device.

13. The braking system as recited in claim 12, wherein the first axle unit is configured to be hydraulically separate from the second axle unit in such a way that the first axle unit and the second axle unit are connected to one another at most via at least one signal line and/or bus line connected at the first control device and at the second control device.

14. The braking system as recited in claim 12, wherein the first motorized brake pressure buildup device is hydraulically connected at the first wheel-brake cylinder and at the second wheel-brake cylinder via a forked first hydraulic path, and a first separating valve and/or a second separating valve being situated in the first hydraulic path in such a way that: i) while brake fluid is transferable into the second wheel-brake cylinder using the first motorized brake pressure build-up device, the first wheel-brake cylinder is decouplable from the first motorized brake pressure buildup device via a closing of the first separating valve, and/or ii) while brake fluid is transferable into the first wheel-brake cylinder using the first motorized brake pressure buildup device, the second wheel-brake cylinder is decouplable from the first motorized brake pressure buildup device via a closing of the second separating valve.

15. The braking system as recited in claim 14, wherein the second motorized brake pressure buildup device is hydraulically connected at the first wheel-brake cylinder and at the second wheel-brake cylinder via a forked second hydraulic path, and a third separating valve and/or a fourth separating valve being situated in the second hydraulic path in such a way that: i) while brake fluid is transferable into the second wheel-brake cylinder using the second motorized brake pressure buildup device, the first wheel-brake cylinder is decouplable from the second motorized brake pressure buildup device via a closing of the third separating valve, and/or ii) while brake fluid is transferable into the first wheel-brake cylinder using the second brake pressure buildup device, the second wheel-brake cylinder is decouplable from the second brake pressure buildup device via a closing of the fourth separating valve.

16. The braking system as recited in claim 11, wherein the first axle unit also includes a main brake cylinder at which a brake actuator of the vehicle is connectable or is connected in such a way that at least one piston of the main brake cylinder delimiting at least one chamber of the main brake cylinder is adjustable using an actuation of the brake actuator by a driver of the vehicle, and the at least one chamber of the main brake cylinder being hydraulically connected via at least one valveless or valve-equipped connecting line at the first motorized brake pressure buildup device: i) at the second motorized brake pressure buildup device, and/or at the first hydraulic path, and/or iii) at the second hydraulic path.

17. The braking system as recited in claim 16, wherein the first motorized brake pressure buildup device is a first plunger device and at least one of the at least one chamber of the main brake cylinder is hydraulically connected at a first plunger chamber of the first plunger device via at least one of the at least one connecting line, and a first opening of the at least one of the at least one of the connecting line at the first plunger chamber being configured in such a way that, when an adjustable first plunger piston of the first plunger device is present in its initial position, brake fluid is transferable out of the main brake cylinder through the first opening into the first plunger chamber, and when the first plunger piston is moved out of its initial position, a brake fluid transfer out of the main brake cylinder through the first opening into the first plunger chamber is prevented using at least one first sealing element attached at the first plunger piston and/or in the first plunger chamber.

18. The braking system as recited in claim 17, wherein the second motorized brake pressure buildup device is a second plunger device and at least one of the at least one chamber of the main brake cylinder is hydraulically connected at a second plunger chamber of the second plunger device via at least one of the at least one connecting line, and a second opening of at least one of the at least one connecting line at the second plunger chamber being configured in such a way that, when an adjustable second plunger piston of the second plunger device is present in its initial position, brake fluid is transferable out of the main brake cylinder through the second opening into the second plunger chamber, and when the second plunger piston is moved out of its initial position, a brake fluid transfer out of the main brake cylinder through the second opening into the second plunger chamber is prevented using at least one second sealing element attached at the second plunger piston and/or in the second plunger chamber.

19. The braking system as recited in claim 16, wherein at least one main brake cylinder decoupling valve is situated in the at least one connecting line.

20. A method for operating a braking system of an at least two-axle vehicle including a first axle unit, which includes a first wheel-brake cylinder mounted at a first wheel of a first axle of the vehicle and a second wheel-brake cylinder mounted at a second wheel of the first axle, and including a second axle unit configured to be hydraulically separate from the first axle unit, which includes a first wheel-brake unit mounted at a first wheel of a second axle of the vehicle and a second wheel-brake unit mounted at a second wheel of the second axle, the method comprising the following steps:
operating a first motorized brake pressure buildup device of the first axle unit hydraulically connected at the first wheel-brake cylinder and at the second wheel-brake cylinder in such a way that the first wheel of the first axle and/or the second wheel of the first axle is decelerated;
operating at least one motorized device of the second axle unit hydraulically or mechanically connected at the first wheel-brake unit and at the second wheel-brake unit in such a way that the first wheel of the second axle and/or the second wheel of the second axle is decelerated; and
operating a second motorized brake pressure buildup device of the first axle unit hydraulically connected at the first wheel-brake cylinder and at the second wheel-brake cylinder in such a way that the first wheel of the first axle and/or the second wheel of the first axle is decelerated.
